(19) United States
(12) Patent Application Publication
(10) Pub. No.: US 2007/0296392 A1
(43) Pub. Date: Dec. 27, 2007

(54) BANDGAP REFERENCE CIRCUITS

(75) Inventors: Hung-I Chen, Kaohsiung City (TW); Yung-Chih Yen, Tainan City (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: MEDIATEK INC., Hsin-Chu (TW)

(21) Appl. No.: 11/761,430

(22) Filed: Jun. 12, 2007

Related U.S. Application Data
(60) Provisional application No. 60/805,609, filed on Jun. 23, 2006.

(51) Int. Cl. G05F 3/16

(52) U.S. Cl. 323/313

(57) ABSTRACT

Bandgap reference circuits capable operating in low voltage environments. In the bandgap reference circuit, an operational amplifier comprises an output terminal and first and second input terminals, first and second transistors are coupled to the operational amplifier, and a first resistor is coupled between the output terminal of operational amplifier and the first transistor. A first resistor ladder is coupled between the output terminal of the operational amplifier and the second transistor and comprises a plurality of second resistors connected in series and a plurality of switches each having a first terminal coupled to a high-impendence path.

### CROSS REFERENCE TO RELATED APPILCATIONS

This application claims the benefit of U.S. Provisional Application No. 60/805609, filed Jun. 23, 2006, and entitled “Linear Voltage Regulator With Undershoot Minimization”, incorporated herein by reference.

### BACKGROUND OF THE INVENTION

1. Field of the Invention

The invention relates to reference circuits, and in particular to bandgap reference circuits capable of providing a reference voltage having no influence on the finite turn-on resistance and temperature coefficient of the switches.

2. Description of the Related Art

Analog circuits make extensive use of voltage and current reference circuits. Analog circuit reference circuits are DC quantities that exhibit little dependence on supply and process parameters and a well-defined dependence on temperature. For example, bandgap reference circuits are probably the most popular high performance reference circuits, as they implement components having positive temperature coefficient and negative temperature coefficient characteristics and the voltages or current of these components are added in a predetermined proportion to generate a value independent of temperature, such value is output as a reference.

### BRIEF SUMMARY OF THE INVENTION

A detailed description is given in the following embodiments with reference to the accompanying drawings.

Embodiments of bandgap reference circuits are provided, in which an operational amplifier comprises an output terminal and first and second input terminals, first and second diode-connected BJT transistors are coupled to the operational amplifier, and a first resistor is coupled between the output terminal of operational amplifier and the first diode-connected BJT transistor. A first resistor ladder is coupled between the output terminal of the operational amplifier and the second diode-connected transistor and comprises a plurality of second resistors connected in series and a plurality of switches each having a first terminal coupled to the first input terminal of the operational amplifier.

The invention provides another embodiment of bandgap reference circuits, in which an operational amplifier comprises an output terminal and first and second input terminals, first and second diode-connected BJT transistors are coupled to the first and second input terminals of the operational amplifier respectively. A first resistor comprises a first terminal coupled to the output terminal of the operational amplifier and a second terminal coupled to the first diode-connected BJT transistor and the first input terminal of the operational amplifier. A first resistor ladder comprises a plurality of second resistors connected in series and a plurality of switches each having a first terminal coupled to a high-impendence path. The switches are controlled by a first set of control signals such that a portion of the second resistors from a first equivalent resistor and the residual portion thereof form a second equivalent resistor.

The invention provides another embodiment of bandgap reference circuits, in which an operational amplifier comprises an output terminal and first and second input terminals, first and second transistors are coupled to the operational amplifier, and a first resistor is coupled between the output terminal of the operational amplifier and the first transistor. A first resistor ladder is coupled between the output terminal of the operational amplifier and the second transistor and comprises a plurality of second resistors connected in series and a plurality of switches each having a first terminal coupled to a high-impendence path.

### BRIEF DESCRIPTION OF THE DRAWINGS

The invention can be more fully understood by reading the subsequent detailed description and examples with references made to the accompanying drawings, wherein:

FIG. 1 shows an embodiment of a bandgap reference circuit;

FIG. 2 shows an embodiment of a resistor ladder;

FIG. 3 shows an embodiment of a bandgap reference circuit; and

FIG. 4 shows another embodiment of a bandgap reference circuit.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

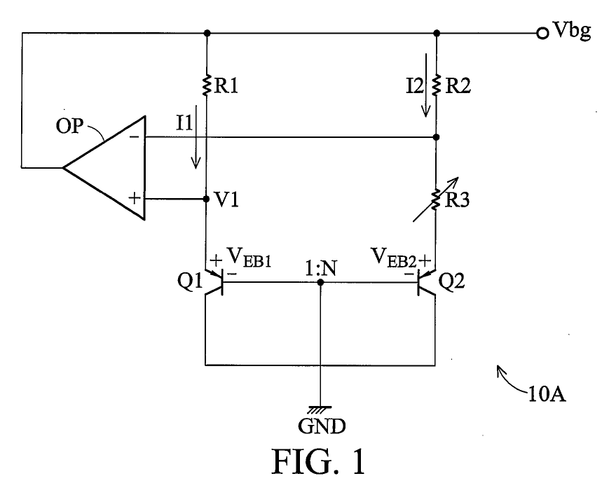

FIG. 1 shows an embodiment of a bandgap reference circuit. As shown, the bandgap reference circuit 10A comprises an operational amplifier OP, two bipolar junction transistors (BJTs) Q1 and Q2, and resistors R1, R2 and R3. For example, the resistors R1 and R2 have the same resistance, and the emitter area of the transistor Q2 can be N times that of the transistor Q1, in which N>1.

If the base current is neglected, the emitter-base voltage V_{EB} of a forward active operation diode can be expressed as:

$${V}_{EB} = \frac{kT}{q} ln ( \frac{{I}_{C}}{{I}_{S}} )$$

Wherein k is Boltzmannis constant (1.38×10⁻²³ J/K), q is the electronic charge (1.6×10⁻²⁹ C), T is temperature, I_{c} is the collator current, and I_{S} is the saturation current.

When the input voltages V1 and V2 of the operational amplifier OP are matched and the size of the transistor Q2 is N times that of the transistor Q1, the emitter-base voltage difference between the transistors Q1 and Q2, ΔV_{EB}, becomes:

$$Δ {V}_{EB} = {V}_{EB 1} - {V}_{EB 2} = \frac{kT}{q} ln N$$

Wherein V_{EB1} is the emitter-base voltage of the transistor Q1, and V_{EB2} is the emitter-base voltage of the transistor Q2.

Because the input voltages V1 and V2 are matched by the operational amplifier OP, the voltages V1 and V2 can be expressed as:

$$V 1 = V 2 = {V}_{EB 1} = {V}_{EB 2} + I 2 \times R 3$$

$$I 2 \times R 3 = {V}_{EB 1} - {V}_{EB 2} = \frac{kT}{q} ln N$$

Thus, the current I2 through the resistors R2 and R3 can be expressed as:

$$I 2 = \frac{{V}_{T}}{R 3} ln N ,$$

wherein thermal voltage

$${V}_{T} = \frac{kT}{q} .$$

Because the resistors R1 and R2 are identical and the input voltages V1 and V2 are matched by the operational amplifier OP, the current I2 can be the same as the current I1.

Accordingly,

$$I 1 = I 2 = \frac{{V}_{T}}{R 3} ln N ,$$

since the thermal voltage V_{T} has a positive temperature coefficient of 0.085 mV/° C., the currents I1 and I2 have positive temperature coefficient.

Thus, the voltage Vbg can be expressed as:

$$Vbg = I 2 \times ( R 2 + R 3 ) + {V}_{EB 2} = I 1 \times R 1 + {V}_{EB 1} = R 1 \times \frac{{V}_{T}}{R 3} ln N + {V}_{EB 1}$$

Because the emitter-base voltage V_{EB} of transistors has a negative temperature coefficient of −2 mV/° C., the voltage Vbg will have a nearly-zero temperature coefficient and low sensitivity to temperature if a proper ratio of resistances of the resistors R1˜R3 is selected.

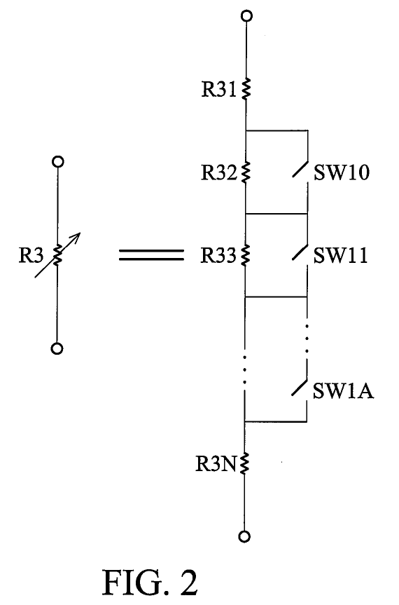

In some embodiments, the resistor R3, for example, can be implemented by a resistor ladder. FIG. 2 shows an embodiment of a resistor ladder. The resistor R3 coupled between the resistor R2 and the transistor Q2 comprises N resistors R31˜R3N connected in series and a plurality of switches SW1˜SW1A connected in series. Each switch is parallel to a corresponding resistor with the exception of resistors R31 and R3N. For example, two terminals of switch SW10 are coupled to two ends of the resistor R32, two terminals of the switch SW11 are coupled to two ends of the resistor R33 and so on. The switches SW10˜SW1N can be implemented by MOS transistors.

Because the switches SW10˜SW1A are disposed in the path of the current I2, such that the non-ideal switch effects, such as, temperature coefficient and finite turn-on resistance, influence bandgap reference circuit parameters. For example, when the switch SW10 is turned on, the current I2 flows through resistor R31, switch SW10 and resistors R33˜R3N. Hence, non-ideal effects on the switch SW10 influence the bandgap reference circuit parameters. Further, if switches SW10˜SW1N are implemented by PMOS transistors, the N-well connected to the power voltage (not shown) also degrades bandgap reference circuit power supply rejection ration (PSRR) performance. After the optimal settings of switch array (SW10˜SW1M) are derived, the switches are replaced with hard-wiring if the PSRR is considered. Due to different characteristics of the switches and wires, the parameters of the bandgap reference circuit will drift.

The best way to prevent finite turn-on resistance and temperature coefficient of the switches is to put them on a high-impedance path, and in an operational amplifier-based bandgap reference circuit, the high-impedance path exists at the input terminals of the operational amplifier. Thus, the invention further provides a bandgap reference circuit which is not affected by the finite turn-on resistance and temperature coefficient of the switches.

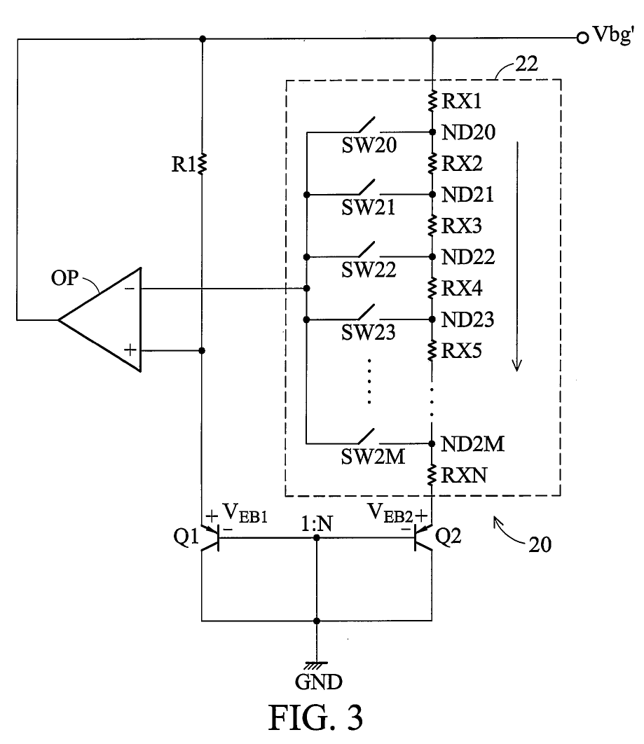

FIG. 3 shows another embodiment of a bandgap reference circuit. As shown, the bandgap reference circuit 20 is similar to that shown in FIG. 1 with the exception of resistor ladder 22. The bandgap reference circuit 20 comprises the two bipolar junction transistors Q1 and Q2, the operational amplifier OP, the resistor R1 and the resistor ladder 22.

The transistor Q1 comprises an emitter coupled to a positive input terminal of the operational amplifier OP, and a base and a collector both coupled to a ground voltage GND. The transistor Q2 comprises an emitter coupled to the resistor ladder 22, and a base and a collector both coupled to the ground voltage GND. Namely, the transistors Q1 and Q2 are diode-connected transistors. The resistor R1 is coupled between the positive input terminal and an output terminal of the operational amplifier OP. The resistor ladder 22 is coupled to the emitter of the transistor Q2, and the output terminal and a negative input terminal of the operational amplifier OP.

The resistor ladder 22 comprises a plurality of resistors RX1˜RXN connected in series and a plurality of switches SW21˜SW2M. The resistor RX1 is coupled between the output terminal of the operational amplifier OP and a node ND20, the resistor RX2 is coupled between the node ND20 and a node ND21, and so on, and the resistor RXN is coupled between the node ND2M and the emitter of the transistor Q2. Each switch SW20˜SW2M has a first terminal coupled to a corresponding node and a second terminal coupled to the negative input terminal of the operational amplifier OP. For example, the switch SW20 is coupled between the negative input terminal of the operational amplifier OP and the node ND20. The switch SW21 is coupled between the negative input terminal of the operational amplifier OP and the node ND21, and so on. The switch SW2M is coupled between the negative input terminal of the operational amplifier OP and the node ND2M.

The resistor string comprising resistors RX1˜RXN has a fixed total resistance, and resistances of the resistors R2 and R3 shown in FIG. 1 can be adjusted by switches SW21˜SW2M. For example, when the switch SW20 is turned on and the switches SW21˜SW2M are turned off, the resistor RX1 serves as a first equivalent resistor (shown as resistor R2 shown in FIG. 1) and the resistor string comprising residual resistors RX2˜RXN serves as a second equivalent resistor (shown as resistor R3 shown in FIG. 1). In another case, when the switch SW21 is turned on and the switches SW20 and SW22˜SW2M are turned off, the resistor string comprising resistors RX1 and RX2 serves as the first equivalent resistor (R2 shown in FIG. 1) and the resistor string composed of resistors RX3˜RXN serves as the second equivalent resistor (R3 shown in FIG. 1). When the switch SW22 is turned on and the switches SW20˜SW21 and SW23˜SW2M are turned off, the resistor string composed of the resistors RX1˜RX3 serves as the first equivalent resistor (R2 shown in FIG. 1) and the resistor string composed of resistors RX4˜RXN serves as the second equivalent resistor (R3 shown in FIG. 1), and so on. The ratio of the first and second equivalent resistors (R2 and R3 shown in FIG. 1) can be adjusted by turning on one of the switches SW21˜SW2M. There is no current flowing through the switches SW21˜SW2M to the operational amplifier OP and the current I2 only flows through the resistors RX1˜RXN and the transistor Q2, because the input terminals of the operational amplifier OP are high-impedance.

Thus, the output voltage Vbg′ of the bandgap reference circuit 20 also has a nearly-zero temperature coefficient and low sensitivity to temperature if a proper ratio of resistances of the resistors R1˜R3 is selected. In some embodiments, the transistors SW20˜SW2M are controlled by a set of control signals from an external control apparatus such that the resistors R2 and R3 can be adjusted to obtain a desired output voltage Vbg′.

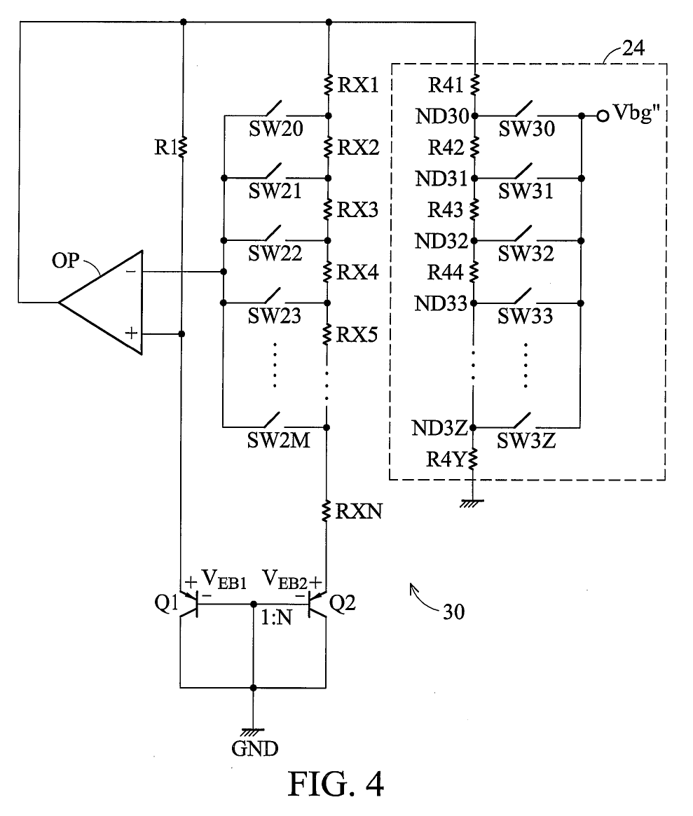

FIG. 4 shows another embodiment of a bandgap reference circuit. As shown, the bandgap reference circuit 30 is similar to that shown in FIG. 3 except the resistor ladder 24. The resistor ladder 24 is coupled between the output terminal of the operational amplifier OP and the ground voltage GND and comprises a plurality of resistors R41˜R4Y connected in series and a plurality of switches SW30˜SW3Z. The resistor R41 is coupled between the output terminal of the operational amplifier OP and a node ND30, the resistor R42 is coupled between the node ND30 and a node ND31, and so on, and the resistor R4Y is coupled between the node ND3Z and GND. The switches SW30˜SW3Z each has a first terminal coupled to a corresponding node and a second terminal coupled to an output terminal.

For example, the switch SW30 is coupled between the output terminal and the node ND30. The switch SW31 is coupled between the output terminal and the node ND31, and so on. The switch SW3Z is coupled between the output terminal and the node ND3Z. The resistor ladder 24 performs a voltage division to the voltage Vbg′ by turning on one of the switches SW30˜SW3Z, such that the voltage Vbg′ can be lower than the voltage Vbg″ thereby operating in a low voltage environment. In some embodiments, the switches SW30˜SW3Z are controlled by another set of control signals from the external control apparatus such that the voltage Vbg″ can be operated in a low voltage environment.

As switches SW20˜SW2M each has one terminal coupled to one input terminal of the operational amplifier, i.e., a high-impedance path, there is no current flowing through any of the transistors SW20˜SW2M to the operational amplifier OP, and thus, non-ideal effects on the transistors SW20˜SW2M (switches) do not influence parameters of the bandgap reference circuit. Because there is no current flowing through the transistors (switches), the parameters of the bandgap reference circuit will not drift due to different characteristics of the switches and wires even if the PSRR is considered and the switches are replaced with hard-wiring after the optimal setting of switches SW20˜SW2M is derived. Thus, the inventive bandgap reference circuit is not affected by the finite turn-on resistance and temperature coefficient of the switches.

The bandgap reference circuits 10, 20 and 30 can act as a functional block for the operation of mixed-mode and analog integrated circuits (ICs), such as data converters, phase lock-loop (PLL), oscillators, power management circuits, dynamic random access memory (DRAM), flash memory, and much more. For example, the bandgap reference circuit 20 provides the output voltage Vbg′ to a core circuit, and the core circuit executes functions thereof accordingly.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A bandgap reference circuit, comprising:
an operational amplifier comprising an output terminal and first and second input terminals;
first and second diode-connected BJT transistors;
a first resistor coupled between the output terminal of operational amplifier and the first diode-connected BJT transistor; and
a first resistor ladder coupled between the output terminal of the operational amplifier and the second diode-connected transistor, the first resistor ladder comprising a plurality of second resistors connected in series and a plurality of switches each having a first terminal coupled to the first input terminal of the operational amplifier.

2. The bandgap reference circuit as claimed in claim 1, wherein the first resistor comprises a first terminal coupled to the output terminal of operational amplifier and a second terminal coupled to the second terminal of the operational amplifier and the first diode-connected BJT transistor.

3. The bandgap reference circuit as claimed in claim 1, wherein the first diode-connected BJT transistor is coupled between the second input terminal of the operational amplifier and a ground voltage and the second diode-connected BJT transistor is coupled between the first resistor ladder and the ground voltage.

4. The bandgap reference circuit as claimed in claim 1, wherein, in first the resistor ladder, each two of the second resistors have a node, and the switches are each coupled between the first input terminal of the operational amplifier and a corresponding node.

5. The bandgap reference circuit as claimed in claim 1, wherein the switches are transistors.

6. The bandgap reference circuit as claimed in claim 1, further comprising a voltage division element coupled to the output terminal of the operational amplifier.

7. The bandgap reference circuit as claimed in claim 6, wherein the voltage division element comprises a second resistor ladder.

8. A bandgap reference circuit, comprising:
an operational amplifier comprising an output terminal and first and second input terminals;
first and second transistors;
a first resistor coupled between the output terminal of the operational amplifier and the first transistor; and
a first resistor ladder coupled between the output terminal of the operational amplifier and the second transistor, the first resistor ladder comprising a plurality of second resistors connected in series and a plurality of switches each having a first terminal coupled to a high-impendence path.

9. The bandgap reference circuit as claimed in claim 8, wherein the first and second transistors are diode-connected BJT transistors.

10. The bandgap reference circuit as claimed in claim 9, wherein the first transistor is coupled between the first input terminal of the operational amplifier and a ground voltage and the second transistor is coupled between the first resistor ladder and the ground voltage.

11. The bandgap reference circuit as claimed in claim 10, wherein the first resistor comprises a first terminal coupled to the output terminal of operational amplifier and a second terminal coupled to the first terminal of the operational amplifier and the first transistor.

12. The bandgap reference circuit as claimed in claim 11, wherein, in the first resistor ladder, each two subsequent second resistors have a node in between, and each switch is coupled between the high-impendence path and a corresponding node.

13. The bandgap reference circuit as claimed in claim 12, further comprising a second resistor ladder coupled to the output terminal of the operational amplifier.

14. The bandgap reference circuit as claimed in claim 13, wherein the high-impendence path is the second input terminal of the operational amplifier.

15. A bandgap reference circuit, comprising:
an operational amplifier comprising an output terminal and first and second input terminals;
first and second diode-connected BJT transistors coupled to the first and second input terminals of the operational amplifier respectively;
a first resistor comprising a first terminal coupled to the output terminal of operational amplifier and a second terminal coupled to the first diode-connected BJT transistor and the first input terminal of the operational amplifier; and
a first resistor ladder coupled between the output terminal of the operational amplifier and the second transistor and comprising a plurality of second resistors connected in series and a plurality of switches each having a first terminal coupled to a high-impendence path, wherein the switches are controlled by a first set of control signals such that a portion of the second resistors form a first equivalent resistor and the residual portion of which form a second equivalent resistor.

16. The bandgap reference circuit as claimed in claim 15, wherein, in the first resistor ladder, each two subsequent second resistors have a node in between, and each switch is coupled between the high-impendence path and a corresponding node.

17. The bandgap reference circuit as claimed in claim 15, wherein the high-impendence path is the second input terminal of the operational amplifier.

18. The bandgap reference circuit as claimed in claim 15, wherein the first and second equivalent resistors have a fixed total resistance, and a resistance ratio of the first and second equivalent resistors is adjusted by the first set of control signals.

19. The bandgap reference circuit as claimed in claim 15, further comprising a second resistor ladder coupled to the output terminal of the operational amplifier, performing a voltage-division according to a second set of control signals.
